(19) United States
(12) Patent Application Publication
(10) Pub. No.: US 2006/0122088 A1
(43) Pub. Date: Jun. 8, 2006

(54) Unit dose two-layer liquid detergent packages

(76) Inventors: Eugene Steven Sadlowski, Cincinnati, OH (US); Vincent John Becks, Hamilton, OH (US); Yousef Georges Aouad, Cincinnati, OH (US); Christopher John Lienhart, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/003,552

(22) Filed: Dec. 3, 2004

(51) Int. Cl. C11D 17/00

(52) U.S. Cl. 510/295; 510/438

(57) ABSTRACT

A unit dose liquid detergent package comprises a) a water insoluble and chemically inert package including a compartment, and b) a two layer liquid detergent composition contained in the compartment. The two layer liquid detergent composition comprises (i) surfactant, (ii) detergent enzyme and enzyme stabilizer, (iii) electrolyte in an amount sufficient to form two layers, a first layer comprising a substantial portion of the surfactant, and a second layer comprising a substantial portion of the enzyme and enzyme stabilizer, and (iv) water.

### FIELD OF THE INVENTION

The present invention is directed to unit dose packages for use, for example, in supplying laundry detergent to a washing machine. More particularly, the invention is directed to unit dose liquid detergent packages comprising a two layer liquid detergent composition.

### BACKGROUND OF THE INVENTION

While detergent compositions have long been provided in bulk form, unit dose forms of detergents have recently received increased attention. Unit dose forms generally comprise the amount of detergent needed for a single cleaning operation, for example a single laundry process in a consumer laundry washing machine or a single dish cleaning process in an automatic dish washing machine. The unit dose forms are preferred by some consumers, in that the dose is pre-measured and, consequently, the unit dose form is faster, easier and less messy to use. Unit dose forms have been disclosed for both solid detergent compositions, for example, in granular or tablet form, and liquid detergent compositions, including gel-type compositions. Liquid detergent compositions in unit dose form are often desired by consumers who are have previously used liquid detergents in bulk form.

Water-soluble unit dose packages containing liquids are also known. See, for instance, Kennedy (U.S. Pat. No. 4,973,416), Dickler et al. (U.S. Pat. No. 6,037,319), Haq (U.S. Pat. No. 4,416,791) and Richardson (U.S. Pat. No. 4,115,292). The packages may contain various amounts, including relatively high, amounts of water. See for instance WO 94/14941, EP 518 689, WO 97/27743, and JP 06/340,899. Additional water-soluble unit dose packages containing liquid laundry detergents in two layers are disclosed in WO 03/52040 and WO 03/52043. Two layer liquid detergent products provide interesting product appearance.

Additional liquid detergent or cleaning compositions having two layers are also disclosed by EP 116422, EP 175485, GB 1247189, and U.S. Pat. Nos. 6,440,924 and 4,348,292, packaged, for example, in a bottle or a water insoluble package. Two layer products are often achieved by employing an electrolyte, which when added to an aqueous surfactant solution, forces the separation of the surfactant from the aqueous phase. However, high electrolyte concentrations typically necessary to form such two layer products often adversely influence other detergent components, particularly in unit dose products wherein it is generally desirable to provide relatively concentrated detergent compositions to reduce the size of the unit dose form. Such adverse influences are particularly problematic upon storage of the detergent products and can result in undesirable precipitation of components and/or discoloring of the liquid detergent products. Further, in unit dose products using water-soluble packaging, electrolytes and detergent component stabilizers can significantly effect the water solubility of the packaging, either decreasing the water solubility to prevent solubilization of the package during a wash cycle, or increasing solubility to prematurely release the contained detergent. Accordingly, further improvements in unit dose detergent products are desired.

### SUMMARY OF THE INVENTION

Accordingly, the present invention provides improved unit dose liquid detergent packages, specifically unit dose liquid detergent packages containing two layer liquid detergent compositions.

More specifically, in one embodiment, the invention is directed to a unit dose liquid detergent package which comprises a) a water insoluble and chemically inert package including a compartment, and b) a two layer liquid detergent composition contained in the compartment. The two layer liquid detergent composition comprises (i) surfactant, (ii) detergent enzyme and enzyme stabilizer, (iii) electrolyte in an amount sufficient to form two layers, a first layer comprising a substantial portion of the surfactant, and a second layer comprising a substantial portion of the detergent enzyme and enzyme stabilizer, and (iv) water.

In an additional embodiment, the invention is directed to a unit dose liquid detergent package which comprises a) a water insoluble and chemically inert package including a first compartment, a second compartment, and a third compartment, b) a two layer liquid detergent composition contained in the first compartment, c) a bleach composition contained in the second compartment, and d) a rinse additive contained in the third compartment. The two layer liquid detergent composition comprises (i) surfactant, (ii) detergent enzyme and enzyme stabilizer, (iii) electrolyte in an amount sufficient to form two layers, a first layer comprising a substantial portion of the surfactant, and a second layer comprising a substantial portion of the detergent enzyme and enzyme stabilizer, wherein the electrolyte comprises citric acid, and (iv) a liquid carrier comprising water and at least one alcohol.

The unit dose packages according to the invention are advantageous for providing easy and simple unit dosing of liquid detergents, for example laundry detergents or automatic dishwashing detergents, and the two layer liquid detergent products provide interesting product appearance. Additionally, the detergent packages allow use of detersive enzyme components while exhibiting good storage stability, both in product consistency and color.

### BRIEF DESCRIPTION OF THE DRAWINGS

The following detailed description describes various embodiments of the invention defined by the claims and will be more fully understood in view of the drawings in which:

FIG. 1 is a top view of a unit dose package according to one embodiment of the invention;

FIG. 2 is a top view of a unit dose package according to another embodiment of the invention;

FIG. 3 is a top view of a unit dose package according to another embodiment of the invention; and

FIG. 4 is a side view of the unit dose package of FIG. 3.

The various embodiments shown in the drawings are fully discussed in the following detailed description, are illustrative in nature and are not intended to be limiting of the claims.

### DETAILED DESCRIPTION OF THE INVENTION

In one embodiment, the invention is directed to a unit dose liquid detergent package which comprises a) a water insoluble and chemically inert package including a compartment, and b) a two layer liquid detergent composition contained in the compartment. The two layer liquid detergent composition comprises (i) surfactant, (ii) detergent enzyme and enzyme stabilizer, (iii) electrolyte in an amount sufficient to form two layers, a first layer comprising a substantial portion of the surfactant, and a second layer comprising a substantial portion of the detergent enzyme and enzyme stabilizer, and (iv) water.

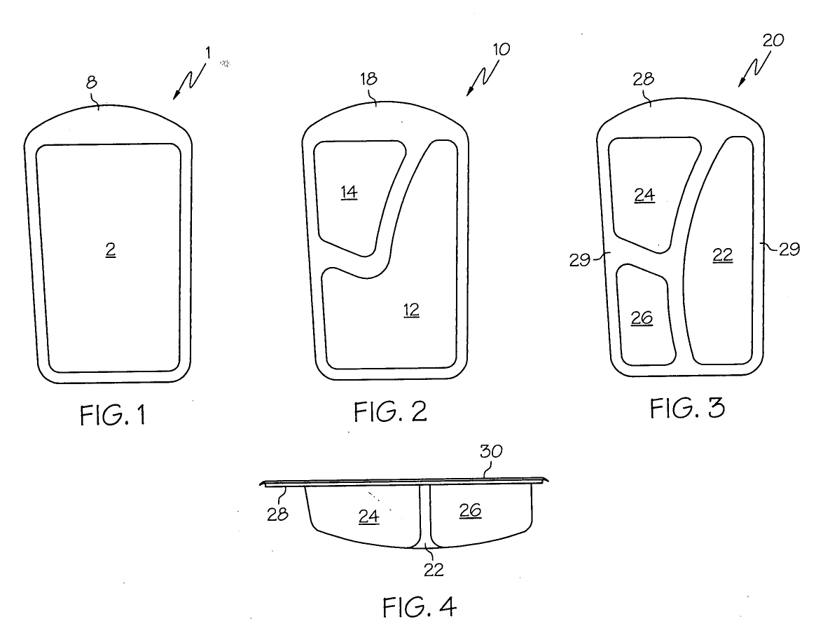

Several embodiments of a package suitable for use in the present unit dose packages are set forth in FIGS. 1-4. With reference to FIG. 1, the package 1 includes a compartment 2 in which the two-layer liquid detergent composition is to be contained. FIGS. 2-4 disclose additional packages suitable for use in unit dose packages according to the present invention. Particularly, the package may include two, three, or more compartments for containing additional additive materials, as desired. For example, as shown in FIG. 2, a package 10 includes a first compartment 12 adapted for containing a two layer liquid detergent composition and a second compartment 14 which may contain an additional wash additive, for example, bleach, or a rinse additive, for example, a fabric softener. As shown in FIG. 3, a unit dose package 20 may be formed with three compartments 22, 24 and 26, respectively, containing the two layer liquid detergent composition and second and third additive materials. This may be useful when the second and/or third additive materials are incompatible with the liquid detergent composition and/or one another, or are intended for dispensing in different cycles or stages of a cleaning process, and may desirably be separately packaged until they are added to the washing machine in a single or multiple cycles. For example, compartment 22 may contain the two layer liquid detergent composition including a detersive enzyme component, while compartment 26 may contain a bleach composition and compartment 24 may contain a fabric softener. Although the compositions from compartments 22 and 26 may be dispensed from their respective compartments during a wash cycle, they are maintained separately until they are dispensed from the package. The package may contain four or more compartments as desired. The unit dose package preferably includes an extended portion 8 (FIG. 1), 18 (FIG. 2), 28 (FIG. 3) which facilitates handling of the unit dose package, and particularly placement of the unit dose package in a dispenser and removal of the package from a dispenser, as will be discussed in further detail below. FIG. 4 sets forth a side view of the unit dose package of FIG. 3 provided with a top wall 30. The compartments of the unit dose package, once filled with the respective materials, are covered and sealed with the wall 30 in any suitable manner. Preferably, the wall 30 is a rupturable film or foil. The wall 30 may be adhered to rim portions 29 of the compartments of the package by adhesive and/or heat sealing and/or other sealing means known in the art.

The package itself can be sized and configured so as to work cooperatively with a dispenser within which it is used. Each compartment of the package is suitably fashioned from water-insoluble material and may be flexible or rigid or have some compartments flexible and other compartments rigid. The compartments may be made from any conventional polymeric material which can be thermoformed or injection molded into the desired structure. Polyolefin materials, for example, polyethylene and/or polypropylene polymers and copolymers, polystyrene and polyester (e.g., polyethylene terephthalate) are non-limiting examples of materials which may be used to form the unit dose package. A polymer material should be chosen which has good heat stability, especially if the unit dose package is to be utilized in dishwashing machines and/or European laundry washing machines where water temperatures approach boiling. The material of the package should also be inert to any chemicals which are present in the additives which are contained in the respective compartments. In one embodiment, the package comprises a one-piece thermoformed tub formed from water-insoluble plastic, such as for example, polypropylene or polyethylene. The tub can be sealed with a thin layer of puncturable or rupturable plastic or metal, e.g., plastic film or aluminum foil.

The unit dose package is adapted for use with a dispenser, for example, in a laundering or dishwashing process. In a specific embodiment, the unit dose package is adapted for use with a dispenser in a laundry system, i.e., a laundry washing machine, in a laundering process. Various dispensers are known for use with unit dose packages as disclosed herein, examples of which are set forth in U.S. patent publication No. 2004/0088796 and the copending, commonly assigned application Ser. Nos. 10/777,512 and 10/777,240 and the application identified by case number 9851.

The compartment of the package which contains the two-phase liquid detergent composition will be of a size sufficient to provide an amount of detergent effective for the desired cleaning process. In one embodiment, the compartment will be of a size sufficient to contain from about 5 to about 100 grams of the two-layer liquid detergent compositions. In a more specific embodiment, the compartment will be of a size sufficient to contain from about 5 to about 90 grams, more specifically from about 15 to about 80 grams, of the two-layer liquid detergent composition. In package embodiments which include two or more compartments, the additional compartments will be of respective sizes sufficient to provide effective amounts of the additive materials contained therein. Typically, these additional compartments will be sized sufficient to contain from about 5 to about 100 grams of the respective additive materials.

The liquid detergent composition comprises a surfactant in an amount sufficient to provide desired cleaning properties. In one embodiment, the liquid detergent composition comprises, by weight, from about 5% to about 70% of the surfactant, and more specifically from about 15% to about 50% of the surfactant. The surfactant may comprise anionic, nonionic, cationic, zwitterionic and/or amphoteric surfactants. In a more specific embodiment, the detergent composition comprises anionic surfactant, nonionic surfactant, or mixtures thereof.

Anionic Surfactants

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Exemplary anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the compositions of this invention and used as or in any anionic surfactant component which may be present. Specific examples of non-alkoyxylated, e.g., non-ethoxylated, alkyl ether sulfate surfactants are those produced by the sulfation of higher C₈-C₂₀ fatty alcohols. Conventional primary alkyl sulfate surfactants have the general formula: ROSO₃⁻M⁺ wherein R is typically a linear C₈-C₂₀ hydrocarbyl group, which may be straight chain or branched chain, and M is a water-solubilizing cation. In specific embodiments, R is a C₁₀-C₁₅ alkyl, and M is alkali metal, more specifically R is C₁₂-C₁₄ and M is sodium.

Specific, nonlimiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3) alkyl sulfates having formulae (I) and (II): 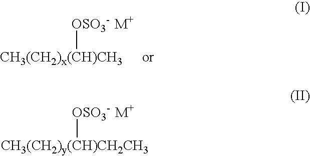
wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x is an integer of at least about 7, preferably at least about 9, and y is an integer of at least 8, preferably at least about 9; d) C₁₀-C₁₈ alkyl alkoxy sulfates (AEₓS) wherein preferably x is from 1-30; e) C₁₀-C₁₈ alkyl alkoxy carboxylates preferably comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); andj) alpha-olefin sulfonate (AOS).

Nonionic Surfactants

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the traadenames Neodol and Dobanol by the Shell Chemical Company.

Another suitable type of nonionic surfactant useful herein comprises the amine oxide surfactants. Amine oxides are mateials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

Anionic/Nonionic Combinations

In the liquid detergent compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic Surfactants

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Zwitterionic Surfactants

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Ampholytic Surfactants

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

The liquid detergent compositions herein comprise one or more detergent or detersive enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or combinations thereof. A preferred enzyme combination comprises one or more, or a cocktail, of conventional detersive enzymes such as protease, lipase, cutinase and/or cellulose, in combination with amylase. Detersive enzymes are described in greater detail in U.S. Pat. No. 6,579,839.

The liquid detergent compositions can comprise one or more of the following exemplary enzymes: Proteases include subtilisins from Bacillus (e.g. subtilis, lentus, licheniformis, amyloliquefaciens (BPN, BPN′), alcalophilus), e.g. Esperase®, Alcalase®, Everlase® and Savinase® (Novozymes), BLAP and variants (Henkel). Further proteases are described in EP130756, WO91/06637, WO95/10591 and WO99/20726. Amylases (α and/or β) include those described in in WO 94/02597 and WO 96/23873. Commercial examples are Purafect Ox Am® (Genencor) and Termamyl®, Natalase®, Ban®, Fungamyl® and Duramyl® (Novozymes). Cellulases include bacterial or fungal cellulases, e.g. produced by Humicola insolens, particularly DSM 1800, e.g. 50 Kda and 43 kD (Carezyme®). Also suitable cellulases are the EGIII cellulases from Trichoderma longibrachiatum. Suitable lipases include those produced by Pseudomonas and Chromobacter groups, specifically, e.g., Lipolase®, Lipolase Ultra®), Lipoprime® and Lipex® from Novozymes. Also suitable are cutinases (EC 3.1.1.50) and esterases. Carbohydrases include mannanase (U.S. Pat. No. 6,060,299), pectate lyase (WO 99/27083) cyclomaltodextringlucanotransferase (WO 96/33267) xyloglucanase (WO 99/02663). It is common practice to modify wild-type enzymes via protein and/or genetic engineering techniques in order to optimize their performance in the detergent compositions.

The amount of detergent enzyme in the liquid detergent composition is effective to enhance cleaning. In specific embodiments, the detergent enzyme is included in an amount of from about 0.001% to about 5%, more specifically from about 0.01% to about 3%, more preferably 0.005% to 0.1% pure enzyme (weight % of composition).

The liquid detergent composition further comprises an enzyme stabilizer. The enzyme can be stabilized using any known stabilizer system, for example calcium and/or magnesium compounds, boron compounds, including boric acid, borax, substituted boric acids, and aromatic borate esters, peptides and peptide derivatives, polyols, low molecular weight carboxylates, and salts thereof, including alkali metal and alkali earth metal salts such as formates, relatively hydrophobic organic compounds, e.g. certain esters, diakyl glycol ethers, alcohols or alcohol alkoxylates, alkyl ether carboxylate, particularly in addition to a calcium ion source, benzamidine hypochlorite, lower aliphatic alcohols and carboxylic acids, N,N-bis(carboxymethyl) serine salts, (meth)acrylic acid-(meth)acrylic acid ester copolymer and PEG, lignin compound, polyamide oligomer, glycolic acid or its salts, poly hexamethylene biguanide or N,N-bis-3-amino-propyl-dodecyl amine or salt; and mixtures thereof. In liquid matrix, the degradation of other enzymes by the proteolytic enzyme can be avoided by protease reversible inhibitors. In one embodiment, the enzyme stabilizer comprises a boron compound, a format compound or a mixture thereof. The enzyme stabilizer is employed in an amount sufficient to substantially maintain activity of the detergent enzyme. In specific embodiments, the composition comprises from about 0.001% to about 5%, more specifically from about 0.01% to about 2%, by weight, of enzyme stabilizer.

The liquid detergent composition employed in the unit dose packages of the present invention includes an electrolyte in an amount sufficient to form two layers in the composition. The first layer comprises a substantial portion of the surfactant while the second layer comprises a substantial portion of the detergent enzyme and the enzyme stabilizer. The term “substantial portion” is intended to mean more than about 70% by weight of the component, more specifically, more than about 80% by weight of the component, and even more specifically, more than about 90% by weight of the component. In further embodiments, the first layer comprises more than about 95% by weight of the surfactant while the second layer comprises more than about 95% by weight of the detergent enzyme and the enzyme stabilizer. In further specific embodiments, the electrolyte is employed in the detergent composition in an amount, by weight, of from about 1% to about 20%, more specifically from about 2% to about 10%.

The electrolyte may comprise any suitable material which forms the two layers in the liquid detergent composition as described. In one embodiment, the electrolyte is an organic acid, and more specifically is a mono- or carboxylic acid compound. In a more specific embodiment, the electrolyte is citric acid. Further, the electrolyte can be neutralized, previous to addition to the composition, or in situ. Suitable neutralizers, providing cations for organic acid electrolytes, include alkanolamines, for example, monoethanolamine, diethanolamine, triethanolamine or isopropylamine, and hydroxides, for example ammonium hydroxide, potassium hydroxide, or the like, and combinations thereof. In a specific embodiment, a combination of one or more alkanolamines and one or more hydroxides is employed in the liquid detergent compositions. In a further embodiment, the electrolyte, for example, citric acid, is premixed with the one or more hydroxides and combined with other detergent ingredients, particularly surfactant, followed by addition of the one or more alkanolamines, for example monoethanolamine.

The liquid detergent composition further comprises water. Generally the amount of water employed in the compositions is relatively low in order to reduce the size of the unit dose package; however, sufficient water, alone or together with an additional solvent, is required to solubilize, suspend and/or disperse the components of the composition. For example, the composition may comprise, by weight, from about 1% to about 50%, and more specifically, from about 2% to about 30%, water. Other types of water-miscible liquids, for example, alcohols such alkanols, diols, and other polyols containing three or more hydroxy groups, ethers, amines, and the like, may be employed as co-solvents or stabilizers. For example, the composition may comprise, by weight, from about 1% to about 40%, and more specifically, from about 1% to about 25% of such water-miscible liquids.

Typically, the two layers are formed in the detergent composition such that the surfactant-containing layer is of lower density and therefore forms above the enzyme- and enzyme stabilizer-containing layer. In one embodiment, a substantial portion of the water is contained in the lower enzyme-containing layer, while the co-solvent, if included, typically is apportioned more evenly between the two layers. Surprisingly, the two layer composition provides good product stability, even upon storage. That is, enzyme activity is substantially maintained as are product clarity, even at low temperatures. The composition coloring is also maintained, and particularly does not substantially darken over time. This combination of properties upon storage is advantageous as often conventional products which exhibit good enzyme activity upon storage also tend to exhibit precipitation of components and/or darkening over time, in some cases due to the inclusion of enzyme stabilizers, while products that avoid precipitation of components and discoloration over time often exhibit significant decreases in enzyme activity. Despite the two layer formation of the detergent composition in the unit dose package, the composition is easily converted to a single phase upon dilution with water to conventional active concentrations.

The difference in density of the two layers of the detergent composition may be sufficient to allow a third layer or soluble solid material to be suspended therebetween. For example, in one embodiment, a solid soluble material such as polyethylene glycol 4000, or particles containing other functional detergent ingredients and formed using polyethylene glycol 4000, can be suspended between the layers of the detergent composition. This provides a visually distinctive way to deliver functional detergent ingredients and/or aesthetic components as suspended speckles, balls, etc., without the use of thickeners. Suitable solid particles may, for example, comprise functional components such as properfume particles, builder particles, bleach catalyst particles or the like. Colored particles made by adding dye to polyethylene glycol 400 may be used to provide speckles. Further embodiments of suitable third layers are disclosed in WO 02/057402.

In one embodiment, the two layers of the liquid detergent composition are of different colors. Typically, the layers exhibit different dye uptake properties which facilitates provision of two layers of different colors.

The detergent compositions of the present invention can also include any number of additional optional ingredients. These include conventional wash, and particularly, laundry, detergent composition components such as detersive builders, chelating agents, anti-redeposition agents, dispersants, soil release agents, hydrotropes, phase stabilizers, pH control agents, perfumes, coloring agents, including dyes and/or optical brighteners, suds suppressors, soil suspending agents, smectite clays, structuring agents, dye transfer inhibiting agents, and other fabric care benefit agents. The various optional detergent composition ingredients, if present, should be utilized at concentrations conventionally employed to bring about their desired contribution to the composition or the cleaning operation. Frequently, the total amount of such optional detergent composition ingredients can range from about 0.01 to about 50%, more preferably from about 1% to about 30%, by weight of the composition. A few of the optional ingredients which can be used are described in greater detail as follows.

The detergent compositions herein may also optionally contain an organic detergent builder material which serves to counteract the effects of calcium, or other ion, water hardness encountered during laundering/bleaching use of the compositions herein. Examples of such materials include the alkali metal citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, C₁₀-C₂₂ fatty acids, and citric acid. Other examples are organic phosphonate type sequestering agents such as those which have been sold by Monsanto under the Dequest tradename and alkanehydroxy phosphonates. Other suitable organic builders include the higher molecular weight polymers and copolymers known to have builder properties. For example, such materials include appropriate polyacrylic acid, polymaleic acid, and polyacrylic/polymaleic acid copolymers and their salts, such as those sold by BASF under the Sokalan trademark. If utilized, organic builder materials will generally comprise from about 0.1% to 10% by weight of the composition. In one embodiment, the electrolyte comprises citrate and the citrate also serves as a builder in the compositions.

Chelating agents control the adverse effects of heavy metal contamination or water hardness (for example, calcium and magnesium ions) in an aqueous bath by binding with metal ions. Any multidentate ligand is suitable as a chelating agent. For example, suitable chelating agents can include, but are not limited to, carboxylates, phosphates, phosphonates, polyfunctionally-substituted aromatic compounds, polyamines, biodegradable compounds, the alkali metal, ammonium or substituted ammonium salts or complexes of these chelating agents, and mixtures thereof. In some cases, chelating agents may improve the performance and efficiency of the desired formulations. Examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

The compositions of the present invention may comprise a hydrotrope. Hydrotrope generally means a compound with the ability to increase the solubilities, preferably aqueous solubilities, of certain slightly soluble organic compounds. Exemplary hydrotopes include the alkyl aryl sulphonates or alkyl aryl sulphonic acids. Preferred alkyl aryl sulphonates include: sodium, potassium, calcium and ammonium xylene sulphonates; sodium, potassium, calcium and ammonium toluene sulphonates; sodium, potassium, calcium and ammonium cumene sulphonates; sodium, potassium, calcium and ammonium substituted or unsubstituted naphthalene sulphonates; and mixtures thereof. Preferred alkyl aryl sulphonic acids include xylene sulphonic acid, toluene sulphonic acid, cumene sulphonic acid, substituted or unsubstituted naphthalene sulphonic acid and mixtures thereof. More preferably, cumene sulphonate or p-toluene sulphonate or mixtures thereof are used.

The detergent compositions herein may also optionally contain low levels of materials which serve to adjust or maintain the pH of the aqueous detergent compositions herein at optimum levels. The pH of the compositions of this invention should range from about 7.0 to about 8.5, more preferably from about 7.5 to about 8.5. Materials such as NaOH can be added to alter composition pH, if necessary.

The detergent compositions may also include, for example, materials selected from the group consisting of catalytic metal complexes, activated peroxygen sources, bleach activators, bleach boosters, photobleaches, free radical initiators and hyohalite bleaches. Examples of suitable catalytic metal complexes include, but are not limited to, manganese-based catalysts such as Mn^{IV}₂ (u-O)₃(1,4,7-trimethyl-1,4,7-triazacyclononane)₂(PF₆)₂ disclosed in U.S. Pat. No. 5,576,282, cobalt based catalysts disclosed in U.S. Pat. No. 5,597,936 such as cobalt pentaamine acetate salts having the formula [Co(NH₃)₅OAc] Ty, wherein “OAc” represents an acetate moiety and “Ty” is an anion; transition metal complexes of a macropolycyclic rigid ligand—abreviated as “MRL”. Suitable metals in the MRLs include Mn, Fe, Co, Ni, Cu, Cr, V, Mo, W, Pd, and Ru in their various oxidation states. Examples of suitable MRLs include: Dichloro-5,12-diethyl-1,5,8,12-tetraazabicyclo[6.6.2]hexadecane Manganese(II), Dichloro-5,12-diethyl-1,5,8,12-tetraazabicyclo[6.6.2]hexadecane Manganese(III) Hexafluorophosphate and Dichloro-5-n-butyl-12-methyl-1,5,8,12-tetraaza-bicyclo[6.6.2]hexadecane Manganese(II). Suitable transition metal MRLs are readily prepared by known procedures, such as taught for example in WO 00/332601, and U.S. Pat. No. 6,225,464. Surprisingly, the present compositions resist differential darkening which is often encountered in detergent compositions containing such catalysts, particularly manganese catalysts.

Suitable activated peroxygen sources include, but are not limited to, preformed peracids, a hydrogen peroxide source in combination with a bleach activator, or a mixture thereof. In a preferred embodiment, a preformed peracid is provided in a separate compartment of the package, and is not combined with the detergent compositions as described herein until the cleaning process is conducted. Suitable preformed peracids include, but are not limited to, compounds selected from the group consisting of percarboxylic acids and salts, percarbonic acids and salts, perimidic acids and salts, peroxymonosulfuric acids and salts, and mixtures thereof. Suitable sources of hydrogen peroxide include, but are not limited to, compounds selected from the group consisting of perborate compounds, percarbonate compounds, perphosphate compounds and mixtures thereof. Suitable types and levels of activated peroxygen sources are found in U.S. Pat. Nos. 5,576,282, 6,306,812 B1 and 6,326,348 B1 that are incorporated by reference.

Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate. Suitable bleach boosters include, but are not limited to, those described U.S. Pat. No. 5,817,614.

As a practical matter, and not by way of limitation, the compositions and cleaning processes herein can be adjusted to provide on the order of at least one part per hundred million of catalytic metal complex in the aqueous washing. When present, hydrogen peroxide sources will typically be at levels of from about 1%, to about 30%, by weight of the composition. If present, peracids or bleach activators will typically comprise from about 0.1% to about 60% by weight of the bleaching composition. As a practical matter, and not by way of limitation, the compositions and cleaning processes herein can be adjusted to provide on the order of at least one part per hundred million of bleach booster in the aqueous washing.

The detergent compositions may contain a perfume, a perfume delivery system or mixture thereof. As used herein the term “perfume” is used to indicate any odoriferous material. Suitable perfumes include but are not limited to one or more aromatic chemicals, naturally derived oils and mixtures thereof. Chemical classes for such aromatic chemicals and essential oils include but are not limited to alcohols, aldehydes, esters, ketones. Suitable perfume delivery systems include but are not limited to perfume loaded cyclodextrins, amine assisted delivery systems, polymer-assisted perfume systems, reactive/pro-perfume systems and inorganic carrier systems. Perfume loaded cyclodextrin delivery systems comprise perfume materials or blends complexed with cyclodextrin type materials—a majority of the cyclodextrin may be alpha-, beta-, and/or gamma-cyclodextrin, or simply beta-cyclodextrin. Processes for producing cyclodextrins and cyclodextrin delivery systems are further described in U.S. Pat. Nos. 3,812,011, 4,317,881, 4,418,144 and 5,552,378. While the level of perfumes, perfume delivery systems and mixtures thereof used in a product depends on the desired level of perfume odor, when used in fluid products such perfumes, perfume delivery systems and mixtures thereof typically comprise from about 0.01% to about 10.0% weight percent of said fluid product.

Each layer of the liquid detergent compositions herein are in the form of an aqueous solution or uniform dispersion or suspension of ingredients, some of which may normally be in solid form, that have been combined with the normally liquid components. Each layer will be acceptably phase stable and will typically have a viscosity which ranges from about 100 to 600 cps, more preferably from about 150 to 400 cps. For purposes of this invention, viscosity is measured with a Brookfield LVDV-II+ viscometer apparatus using a #21 spindle.

The liquid detergent compositions herein can be prepared by combining the components thereof in any convenient order and by mixing, e.g., agitating, during addition of components and/or by mixing the resulting component combination. Allowing the composition to stand after mixing results in formation of the two layer liquid detergent composition. In a specific preparation process, a liquid matrix is formed containing at least a major proportion, and preferably substantially all, of the surfactant components, and any co-solvent, and optionally, any organic neutralizer and other optional liquid components with the liquid components being thoroughly admixed by imparting shear agitation to this liquid combination. For example, rapid stirring with a mechanical stirrer may usefully be employed. While shear agitation is maintained, substantially all remaining liquid and any solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, the enzyme stabilizer and enzymes are incorporated. Thus, the enzyme component is preferably added to the aqueous liquid matrix last, although other methods may suitably be employed where enzyme components are added earlier in the process, but preferably after enzyme stabilizer has been added.

As a variation of the composition preparation procedure hereinbefore described, one or more of the solid components may be added to the agitated mixture as a solution or slurry of particles premixed with a minor portion of one or more of the liquid components. After mixing is complete and the composition stands without agitation, the two layers form in a phase stable manner.

The compositions of this invention, prepared as hereinbefore described, can be used to form aqueous washing solutions for use in cleaning, and preferably for the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith.

An effective amount of the liquid detergent compositions herein added to water to form aqueous cleaning, for example, laundering, solutions can comprise amounts sufficient to form from about 500 to 3,000 ppm of the detergent compositions herein will be provided in aqueous washing solution.

### EXAMPLE

This example demonstrates the preparation of a two layer liquid detergent composition according to a specific embodiment of the invention. In this example, and throughout the specification, parts and percentages are by weight unless otherwise specified.

The following components are combined and mixed according to a process as described herein:

TABLE 1
Detergent

| Ingredient | Weight % |
|---|---|
| linear alkylbenzenesulfonic acid | 24.6% |
| Neodol 23-9 | 17.7% |
| C12 dimethylamine oxide | 1.3% |
| citric acid | 7.8% |
| DTPA | 0.3% |
| monoethanolamine | 12.2% |
| amine ethoxylate polymers | 7.8% |
| protease | 2.2% |
| amylase | 0.3% |
| 1,2-propanediol | 7.2% |
| ethanol | 4.3% |
| calcium and sodium formate | 0.3% |
| borax | 1.0% |
| fluorescent whitening agent | 0.3% |
| dye | 0.001% |
| silicone suds suppressor | 0.1% |
| water | 12.6% |
| total | 100% |

wherein: DTPA - diethylenetriaminepentaacetic acid, sodium salt

After mixing, the composition is allowed to stand and two clear layers form. The top layer is determined to comprise 77% by volume of the composition and 73.8% by weight of the composition and has a density of about 1.06. Based on enzyme and ¹H NMR analysis, the top layer comprises surfactant, monoethanolamine, co-solvents, brightener and polymers. The bottom layer is determined to comprise 23% by volume of the composition and 26.2% by weight of the composition, and has a density of about 1.26. The enzyme and ¹H NMR analysis determines that the bottom layer comprises citrate, monoethanolamine, about 97% by weight of the enzymes, most of the borate stabilizer, most of the water and a portion of the co-solvents. The two layer composition exhibits good enzyme stability and clarity, even at lower temperatures. The composition provides a compact, heavy duty liquid detergent composition and can be diluted to give a single phase heavy duty liquid composition with conventional active concentration by combining 53 parts of the composition with 47 parts additional water, providing a total water content in the diluted composition of about 54 weight percent. As the layers exhibit different dye uptake properties, a significant color difference between the layers is observed. Additionally, while the top layer has a relatively thicker rheology than the bottom layer, both layers exhibit acceptable rheology. Further, similar compositions including dichloro(4,11-diethyl-1,4,8,11-tetraazabicyclo[6.6.2]hexadecane)manganese bleaching catalyst do not exhibit darkening when aged. Thus, these compositions also exhibit good color stability.

The two layer liquid detergent composition described above is advantageously provided in a first compartment of a package having two additional compartments. The second compartment contains a bleach composition as follows:

TABLE 2
Bleach Suspension

| Ingredient | Weight % |
|---|---|
| PAP | 15.6% |
| citric acid | 2.0% |
| sodium hydroxide | 0.5% |
| xanthan gum | 0.5% |
| stabilizer | 0.8% |
| TMBA | 0.2% |
| water | 80.5% |
| total | 100% |

wherein: PAP-6-phthalimidoperoxyhexanoic acid
Stabilizer is a modified terephthalate/propylene gycol copolymer
TMBA - 3,4,5-trimethoxybenzoic acid

The third compartment contains an acid rinse having the following composition:

TABLE 3
Acid Rinse

| Ingredient | Weight % |
|---|---|
| maleic acid | 22.4% |
| Neodol 23-5 | 3.3% |
| perfume | 1.3% |
| water | 73.0% |
| total | 100% |

Thus, the resulting unit dose package provides a simple and convenient means for addition of laundry additives to a washing machine. Moreover, the two layer liquid detergent composition exhibits good stability so that the consumer is provided with a reliable product.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A unit dose liquid detergent package, comprising
a) a water insoluble and chemically inert package including a compartment, and
b) a two layer liquid detergent composition contained in the compartment, the two layer liquid detergent composition comprising
(i) surfactant;
(ii) detergent enzyme and enzyme stabilizer;
(iii) electrolyte in an amount sufficient to form two layers, a first layer comprising a substantial portion of the surfactant, and a second layer comprising a substantial portion of the enzyme and enzyme stabilizer; and
(iv) water.

2. The unit dose detergent package according to claim 1, wherein the water insoluble and chemically inert package is formed of a material comprising polyolefin polymer.

3. The unit dose detergent package according to claim 2, wherein the polyolefin comprises polyproplylene.

4. The unit dose detergent package according to claim 1, wherein the water-insoluble and chemically inert package includes at least one additional compartment containing an additional laundry additive.

5. The unit dose detergent package according to claim 4, wherein the additional compartment contains a rinse additive.

6. The unit dose detergent package according to claim 1, wherein the water-insoluble and chemically inert package includes two additional compartments, one containing a bleach composition and one containing a rinse additive.

7. The unit dose detergent package according to claim 1, wherein the two layer liquid detergent composition comprises, by weight,
(i) from about 5% to about 70% of the surfactant;
(ii) from about 0.001% to about 5% detergent enzyme and from about 0.001% to about 5% enzyme stabilizer;
(iii) from about 1% to about 20% electrolyte; and
(iv) from about 1% to about 50% water.

8. The unit dose detergent package according to claim 1, wherein the two layer liquid detergent composition comprises, by weight,
(i) from about 15% to about 50% of the surfactant;
(ii) from about 0.01% to about 3% detergent enzyme and from about 0.01% to about 2% enzyme stabilizer;
(iii) from about 2% to about 10% electrolyte; and
(iv) from about 2% to about 30% water.

9. The unit dose detergent package according to claim 8, wherein the two layer liquid detergent composition further comprises from about 1% to about 25% water-miscible co-solvent.

10. The unit dose detergent package according to claim 9, wherein the water-miscible co-solvent comprises an alkanol, diol, polyol containing three or more hydroxy groups, or a mixture thereof.

11. The unit dose detergent package according to claim 1, wherein the electrolyte comprises citric acid.

12. The unit dose detergent package according to claim 1, wherein the two layer liquid detergent composition further comprises a neutralizer.

13. The unit dose detergent package according to claim 1, wherein the neutralizer comprises a hydroxide, an alkanolamine, or a mixture thereof.

14. The unit dose detergent package according to claim 1, wherein the enzyme stabilizer comprises a boron compound, a formate, or a mixture thereof.

15. The unit dose detergent package according to claim 1, wherein the two layer liquid detergent composition further comprises a manganese bleach catalyst.

16. The unit dose detergent package according to claim 1, wherein the two layer liquid detergent composition further comprises at least one dye and the uptake of the dye to the two layers is different, whereby the two layers differ from one another in color.

17. The unit dose detergent package according to claim 1, wherein the two layer liquid detergent composition further comprises a chelating agent.

18. The unit dose detergent package according to claim 1, wherein the two layer liquid detergent composition further comprises one or more laundry detergent components selected from the group consisting of detergent builders, chelating agents, anti-redeposition agents, dispersants, soil release agents, hydrotropes, phase stabilizers, pH control agents, perfumes, dyes, brighteners, suds suppressors, and suds boosters.

19. The unit dose detergent package according to claim 1, wherein the compartment contains from about 5 to about 100 grams of the two layer liquid detergent composition.

20. A unit dose liquid detergent package, comprising
a) a water insoluble and chemically inert package including a first compartment, a second compartment, and a third compartment,
b) a two layer liquid detergent composition contained in the first compartment, the two layer liquid detergent composition comprising
(i) surfactant;
(ii) detergent enzyme and enzyme stabilizer;
(iii) electrolyte in an amount sufficient to form two layers, a first layer comprising a substantial portion of the surfactant, and a second layer comprising a substantial portion of the enzyme and enzyme stabilizer, wherein the electrolyte comprises citric acid; and
(iv) a liquid carrier comprising water and at least one alcohol;
c) a bleach composition contained in the second compartment, and
d) a rinse additive contained in the third compartment.
